(19) United States
(12) Patent Application Publication
(10) Pub. No.: US 2004/0176519 A1
(43) Pub. Date: Sep. 9, 2004

(54) Fishing lure

(75) Inventor: Michael T. Shelton, Goose Creek, SC (US)

Correspondence Address: ROBERT H. HAMMER III, P.C., 3121 SPRINGBANK LANE, SUITE I, CHARLOTTE, NC, 28226, US

(73) Assignee: Z-Man Fishing Products, Inc.

(21) Appl. No.: 10/378,489

(22) Filed: Mar. 3, 2003

(51) Int. Cl. C08L 1/00

(52) U.S. Cl. 524/445; 524/493; 524/450; 524/451; 524/449; 524/502; 524/505

(57) ABSTRACT

A fishing lure is a shaped mixture of a synthetic rubber polymer and an oil. A coating of a permanent detackifier is spread over the surface of the lure.

### FIELD OF THE INVENTION

A fishing lure is made of a synthetic rubber having a non-tacky surface.

### BACKGROUND OF THE INVENTION

Many commercially available fishing lures and baits are made from plastisol. Plastisol is a dispersion or emulsion of polyvinyl chloride (PVC) resin in a plasticizer. Lures and baits made of various plastisols have been widely accepted. They can be molded into various shapes, are easily colored, and are relatively inexpensive. Additionally, they appear lifelike. The plastisol fishing bait, however, is deficient in that it is not very flexible, it is susceptible to tearing, it is relatively hard, it is perceived as environmentally unsafe, and while it appears likelife, it does not feel lifelike.

Recently, it has been proposed that these fishing lures be made of a synthetic rubber as opposed to plastisols. Price, S., “New soft plastic have fishing world excited,” BASSMASTER, July 2002. Stout, L., “Revolutionary Plastics, New technology may radically alter soft plastic lure market,” B.A.S.S. Times, and U.S. Pat. Nos. 5,884,639, 6,117,176, and 6,148,830. Specifically, these synthetic rubbers are thermoplastic elastomers (TPE); and more specifically, they are styrenic block copolymer. These new lures are a significant improvement over the plastisol lures. The new lures can be colored, shaped, are softer, and are elastic. These new lures not only look lifelike, but they also feel lifelike.

These synthetic rubbers, however, are extremely tacky. When they come in contact with materials, they adhere to those materials. For example, these lures are normally packaged in resealable plastic bags. When the bag is opened and the lure is removed, it sticks to the other lures in the bag. This is unappealing to the fisherman. When lures are stored in a tackle box, they stick to one another as well as to the box. This is also unappreciated by the fisherman. Moreover, in certain types of fishing in order to get to the fish, it is desirable to get in close to the shoreline, as well as, under brush. However, fishing lures made of these tacky synthetic rubbers are prone to adhere to the surrounding brush or other natural or manmade obstructions. With plastisol lures, a sharp yank on the line usually breaks the lure free. The new synthetic rubber lures, on the other hand, will stretch and will not break like the plastisol lures.

Accordingly, there is a need to lessen surface tack of lures made from these synthetic rubbers.

In U.S. Pat. Nos. 5,884,639, 6,117,176, and 6,148,830 surface tack is reduced by mixing a stearic acid compound into the synthetic rubber. The stearic acid compounds include stearic acid (octadecanoic acid); metal stearates; polyethylene glycol distearate, polypropylene glycol ester or fatty acid, and polytetramethylene oxide glygol distearate; waxes; stearic acid and waxes; and metal stearates and waxes. This method of detacking the surface may be appropriate in some applications; but it is inappropriate for fishing lures because the stearic compounds negatively impact the dyes used to color the lures. Alternatively, the surface may be detackified by coating with a silicone oil. This method provides a temporary solution. But, as the lure is used repeatedly in water, the oil is washed from the surface of the lure and it reverts to its tacky nature. Accordingly, coating with silicone oil does not provide a permanent solution to the surface tack problem.

Accordingly, there is a need for a permanently detackified fishing lure made of a synthetic rubber.

### SUMMARY OF THE INVENTION

A fishing lure is a shaped mixture of a synthetic rubber polymer and an oil. A coating of a permanent detackifier is spread over the surface of the lure.

### DETAILED DESCRIPTION OF TH INVENTION

Lures and baits may come in many various shapes. Lure and bait will be used interchangeably hereinafter. For example, the shape may be that of a lizard or a worm. Other shapes include: salamanders, fan tails, curly tail jigs, quad tail jigs, curly tail worms, split-tails, worm-crawfish, minnows, double tails, ripple tail worms, and the like. For example, see U.S. Pat. No. 4,993,183 incorporated herein by reference.

The shaped object is a mixture of synthetic rubber polymer and oil. The synthetic rubber polymer is preferably a thermoplastic elastomer (TPE). The thermoplastic elastomer is preferably a styrenic block copolymer. The styrenic block copolymers typically include styrene end blocks and mid blocks selected from the group consisting of ethylene, propylene, butylene, isoprene, and combinations thereof. The synthetic rubber polymer may be a mixture of one or more of the aforementioned copolymers. For example, see U.S. Pat. Nos. 4,589,223; 5,618,882; 5,884,639; 6,117,176; 6,148,830; 6,455,623, and U.S. patent application Publications Nos. 2002/0188057 and the three other applications filed in the name of John Y. Chen on the same day as said publication and mentioned in said publication in Paragraph [0001] and entitled Tear Resistant Gelatinous Elastomer Compositions and Articles For Use as Fishing Bait (Docket 46), Gelatinous Food-Elastomer Compositions and Articles for Use as Fishing Bait (Docket 47), and Gelatinous Food-Elastomer Compositions and Articles (Docket 48), each is incorporated herein by reference. In the mixture, the oil is added in excess (by weight) to the synthetic rubber polymer. For example, see U.S. Pat. Nos. 5,618,882; 5,884,639; 6,117,176; 6,148,830, and U.S. patent application Publications Nos. 2002/0188057 and the three other applications filed in the name of John Y. Chen on the same day as said publication and mentioned in said publication in Paragraph [0001] and entitled Tear Resistant Gelatinous Elastomer Compositions and Articles For Use as Fishing Bait (Docket 46), Gelatinous Food-Elastomer Compositions and Articles for Use as Fishing Bait (Docket 47), and Gelatinous Food-Elastomer Compositions and Articles (Docket 48), each is incorporated herein by reference.

The shaped lure is coated with a permanent detackifier. The detackifier is, preferably, a particulate having an average particle size in the approximate range of 2 nanometers to 10 microns and a surface area of less than 1000 square meters per gram. The most preferred particulate has an average particle size of 0.2-0.3 microns and a surface area of 380 square meters per gram. The detackifier may be selected from the group consisting of silica gels, natural silicas, fumed silicas, minerals, zeolites (natural or synthetic), organic materials, decorative or ornamental compounds, pigments, and combinations thereof. The minerals may be selected from the group consisting of talcs, china clays, chalks, limestone, mica, coated mica, and mixtures thereof. The organic materials may be selected from the group of spherical silicon resins (e.g., Tospearl® from G.E. Silicones), methylmethacrylate resins (e.g., Epostar® from Nippon Shokobai), and combinations thereof. The decorative or ornamental compounds may be selected from the group consisting of glitters, pearlizing agents, flocking, beads, reflective coatings, and combinations thereof. The pigments may be selected from the group consisting of interference pigments, iridescent pigments, and combinations thereof. The preferred detackifier is a fumed silica. Such fumed silicas are commercially available under the tradename CAB-O-SIL® EH-5 from Cabot Corporation, Tuscola, Ill. and ZEOTHIX® from J.M. Huber Corporation, Havre de Grace, Md. Permanent, as used herein, refers to the detackifying coating's ability to maintain its functionality in spite of repeated usage or handling or in spite of washings associated with usage.

The detackifying coating may further comprise a coating oil. The coating oil is preferably a silicone. The silicone preferably has a viscosity in the approximate range of 50 centipoises to 1000 centipoises. The weight ratio of the coated lure to the coating oil is approximately 8000:25±20. The preferred weight ratio is 8000:10.

The fishing lure may additionally include a decorative coating. The decorative coating may be selected from the group consisting of glitters, pearlizing agents, flocking, beads, reflective coatings, and combinations thereof. These decorative or ornamental coatings can simultaneously perform the decorative function and the detackifying function.

The fishing lure may further include flavorings or fish attractants. For example see: U.S. Pat. Nos. 4,530,179; 4,726,138; 4,887,376; 4,927,643; 4,998,370; and 5,720,996, each is incorporated herein by reference. These flavorants and fish attractants may be incorporated into the synthetic polymer, or coated onto the surface of the lure, or incorporated with one of the foregoing coatings.

In manufacture, the shaped mixture is formed. It is then coated with the permanent detackifier. The shaped mixture will have a chalky appearance. Thereafter, the silicone is applied. Then, the chalky appearance disappears.

The present invention may be embodied in other forms without departing from the spirit and the essential attributes thereof, and, accordingly, reference should be made to the appended claims, rather than to the foregoing specification, as indicated the scope of the invention.

In the claims:

1. A fishing lure comprises
a shaped mixture of a synthetic rubber polymer and oil, and
a coating of a permanent detackifier thereon.

2. The fishing lure of claim 1 wherein said detackifier being selected from the group consisting of silica gels, natural silicas, fumed silicas, minerals, zeolites (natural or synthetic), organic materials, decorative or ornamental compounds, pigments, and combinations thereof.

3. The fishing lure of claim 2 wherein said minerals being selected from the group consisting of talcs, china clays, chalks, limestone, mica, coated mica, and combinations thereof.

4. The fishing lure of claim 2 wherein said organic materials being selected from the group consisting of spherical silicon resins, methylmethacrylate resins, and combinations thereof.

5. The fishing lure of claim 1 wherein said detackifier further comprises a particulate having a diameter in the approximate range of 2 nanometers to 10 microns and a surface area less than 1000 square meters per gram.

6. The fishing lure of claim 1 wherein said synthetic rubber further comprises a thermoplastic elastomer.

7. The fishing lure of claim 6 wherein said thermoplastic elastomer further comprises styrenic block copolymer.

8. The fishing lure of claim 7 wherein said thermoplastic elastomer further comprises more than one styrenic block copolymer.

9. The fishing lure of claim 1 wherein said mixture comprises by weight more oil than synthetic rubber.

10. The fishing lure of claim 1 wherein said coating further comprises a coating oil.

11. The fishing lure of claim 10 wherein said oil comprises silicon.

12. The fishing lure of claim 11 wherein said silicon having a viscosity in the approximately range of 50 centipoises to 1000 centipoises.

13. The fishing lure of claim 10 wherein a weight ratio of said shaped mixture to said coating oil being 8000:25±20.

14. The fishing lure of claim 10 wherein said weight ratio being 8000:10.

15. The fishing lure of claim 1 further comprising a decorative coating.

16. The fishing lure of claim 1 further comprising a fish attractant or flavoring.

17. A fishing lure comprises:
a shaped mixture of a synthetic rubber polymer and oil, said synthetic rubber polymer being one or more styrenic block copolymers, said oil being in excess by weight of said synthetic rubber polymer, and
a coating of a permanent detackifier thereon, said detackifier being a particulate having a diameter in the approximate range of 2 nanometers to 10 microns.

18. The fishing lure of claim 17 wherein said detackifier being selected from the group consisting of silica gels, natural silicas, fumed silicas, minerals, zeolites (natural or synthetic), organic materials, decorative or ornamental compounds, pigments, and combinations thereof.

19. A fishing lure comprises:
a shaped mixture of a synthetic rubber polymer and oil, said synthetic rubber polymer being one or more styrenic block copolymers, said oil being in excess by weight of said synthetic rubber polymer, and
a coating of a permanent detackifier thereon, said coating further comprises a particulate having a surface area of less than 1000 square meters per gram and a coating oil, wherein a weight ratio of the shaped mixture to said coating oil being 8000:25 ±20.

20. The fishing lure of claim 19 wherein said detackifier being selected from the group consisting of silica gels, natural silicas, fumed silicas, minerals, zeolites (natural or synthetic), organic materials, decorative or ornamental compounds, pigments, and combinations thereof.
